(19) United States
(12) Patent Application Publication
(10) Pub. No.: US 2012/0237422 A1
(43) Pub. Date: Sep. 20, 2012

(54) METHOD AND PLANT FOR FLUE GAS DE-NOXING

(75) Inventors: Florian WINKLER, Munchen (DE); Nicole Schodel, Munchen (DE)

(73) Assignee: LINDE AKTIENGESELLSCHAFT, Munchen (DE)

(21) Appl. No.: 13/419,472

(22) Filed: Mar. 14, 2012

(30) Foreign Application Priority Data
Mar. 15, 2011 (DE) 10 2011 014 007.7

(51) Int. Cl. B01D 53/56

(52) U.S. Cl. 423/235; 422/170

(57) ABSTRACT

The invention relates to a method for depleting nitrogen oxides from an oxygen-containing gas stream. The gas stream is brought into contact with a scrubbing solution containing ammonia and ammonium sulphite in a NO₂ reduction, whereby NO₂ is reduced to N₂. NO is reacted with ammonia and oxygen to form ammonium nitrite in an NO elimination step which proceeds at elevated pressure. Likewise, the invention also relates a plant for operating the method according to the invention.

### SUMMARY OF THE INVENTION

The present invention relates to a method and a plant for removing nitrogen oxides from combustion exhaust gases wherein the gas stream is brought into contact with a scrubbing solution containing ammonia and ammonium sulphite in a reduction step, to reduce NO₂ to N₂, and nitrogen monoxide present in the gas stream is reacted with ammonia and oxygen to form ammonium nitrite in an NO elimination step.

The exhaust gases produced from the combustion of carbonaceous energy carriers must be purified to remove oxides of sulphur and nitrogen. In the power plant industry, selective catalytic reduction (SCR) has established itself as a common procedure for removing nitrogen oxides (NOₓ), in which nitrogen oxides are reacted with a reducing agent, such as urea or ammonia, in the presence of a catalyst, e.g. vanadium-titanium oxide. The semi-dry method is typically used for removing sulphur oxides (SOₓ).

A further known method for separating off nitrogen oxides and sulphur oxides is the Walter simultaneous method. See, for example, Michael Schultes, Abgasreinigung, Springer Verlag Berlin Heidelberg 1996, p. 142-143. This method has three steps and operates with ammonia and ozone. In the first step, the SOₓ is removed by ammonia-alkaline scrubbing:

SO₂+2NH₃+H₂O→(NH₄)₂SO₃

SO₃+2NH₃+H₂O→(NH₄)₂SO₄.

Depending on residence time and oxygen content, the sulphite is additionally oxidized to sulphate. In the second step, the NOₓ is extracted by scrubbing with ozone-containing water and reacted with ammonia to form ammonium nitrite and ammonium nitrate. The nitrite is oxidized to nitrate by the atmospheric oxygen present:

NO+O₃→NO₂+O₂

2NO₂+2NH₃+H₂O→NH₄NO₂+NH₄NO₃

NH₄NO₂+0.5O₂→NH₄NO₃.

In a third step, for safety, the NO₂ and O₃ that have broken through are reduced to O₂ and N₂:

2NO₂+4(NH₄)₂SO₃→N₂+4(NH₄)₂SO₄

O₃+(NH₄)₂SO₃→(NH₄)₂SO₄+O₂.

The method disclosed in DE102008062496A1 is a simplification of this method. By using high pressures in the alkaline scrubbing, the feed of ozone is dispensed with, since NO is already oxidized to NO₂ by the oxygen present.

2NO+O₂→NO₂.

This NO₂ is reacted by the ammonia-alkaline scrubbing solution in the presence of NO to form nitrite:

NO+NO₂+2NH₃+H₂O→2NH₄NO₂.

At high NO₂ values, nitrate is formed by the following competing reaction:

2NO₂+2NH₃+H₂O→NH₄NO₂+NH₄NO₃.

The nitrites can be reacted to nitrogen by the thermal reduction:

NH₄NO₂→N₂+2H₂O.

However, by using high pressures in this method, NO₂ and nitrate are also produced to an increased extent during scrubbing, which can not be thermally reduced and therefore must be separated off as salt.

In principle, when the methods are coupled, an ammonium sulphate solution is formed which can be used as fertilizer. On the basis of the tradition of gypsum production from sulphur oxides in flue gases, this solution can also be converted to gypsum (CaSO₄.2H₂O). For this purpose, the double-alkali method can be used. See, for example, Campbell et al. (U.S. Pat. No. 4,231,995). By exchange with the alkaline medium, gypsum is precipitated from an ammonium sulphate solution:

(NH₄)₂SO₄+CaO→2NH₃+CaSO₄+H₂O.

Traditionally, the most important desulphurization method is the conversion of SOₓ to gypsum by wet-limestone scrubbing. See, for example, Kuroda et al. (U.S. Pat. No. 4,487,784). The double alkali processes, despite having lower susceptibilities to problems, have not established themselves over the wet-limestone scrubbing process.

The oxyfuel method uses oxygen-enriched air or pure oxygen for combustion. Since the exhaust gas stream produced in this method substantially comprises carbon dioxide, the method is of interest in connection with strategies for sequestering or utilizing the CO₂ and is being intensively developed.

The development of such combustion methods and the separation of CO₂ for minimizing CO₂ emissions offer new possibilities for eliminating pollutants from flue gases. The wet-chemical elimination of nitrogen oxides, in conventional combustion processes, failed owing to the high working medium costs for the NO oxidation (catalyst, ozone or H₂O₂). This oxidation can, as described in DE102008062496A1, proceed spontaneously in the NOₓ scrubbing owing to the fact that elevated pressure are used in oxyfuel methods and thus the exhaust gas is obtained at elevated pressure.

Against this background, it is an object of the present invention to provide means and methods which make possible elimination of oxides of nitrogen and sulphur from flue gas in a method which is simple in terms of apparatus and is economically acceptable.

Upon further study of the specification and appended claims, other objects and advantages of the invention will become apparent.

These objects are achieved by means and methods described further herein.

The invention is based on the principle of removing nitrogen oxides from an exhaust gas stream by scrubbing with a basic scrubbing medium, wherein nitrogen dioxide is reduced by sulphite that is present in the scrubbing solution without the involvement of a catalyst.

According to a first aspect of the invention, for this purpose a method is provided for depleting nitrogen oxides from an oxygen-containing gas stream. The gas stream is brought into contact with a scrubbing solution containing ammonia and ammonium sulphite in a reduction step, whereby NO₂ present in the gas stream is reduced to N₂. In an NO elimination step preferably proceeding downstream from the reduction step, nitrogen monoxide present in the gas stream is reacted with ammonia and oxygen to form ammonium nitrite. The reaction of the nitrogen monoxide in the NO elimination step proceeds in this case at elevated pressure. Elevated pressure, in the context of the present description, is taken to mean at least 2 bar. Pressures of 0 to 40 bar are preferred, and still more preferred are pressures of 20-27 bar.

The gas stream in this case is preferably the exhaust gas stream from an oxyfuel plant, but other industrial processes also come into consideration in which exhaust gases containing NOₓ and SOₓ are formed and must be purified. Particular preference in this case is given to an oxygen content of at least 3% in the exhaust gas stream. The gas stream therefore contains, in addition to oxygen (e.g., 3-8 vol. %) and the SOₓ (e.g., 0.2-0.5 vol. %) and NOₓ (e.g., 100-800 vppm) impurities that are to be separated off, at least carbon dioxide (e.g., 90-95 vol. %) and also possibly nitrogen (e.g., 0-5 vol. %), further air components and combustion products. The scrubbing solutions listed here can contain not only the substances indicated, but also other substances. A person skilled in the art knows that the word “contains” here is therefore not used in the exclusive sense.

According to a preferred embodiment of the invention, the scrubbing solution containing ammonium sulphite is fed from a nearby (proximal) scrubbing step which is upstream of the reduction step. In this upstream scrubbing step the gas stream is contacted with an ammonia-containing scrubbing solution to remove SOx. The product of the (proximal) ammoniacal scrubbing of the gas stream, the ammonium-sulphite-containing scrubbing solution, can then be used for reducing the nitrogen dioxide in the downstream reduction step.

Further preference is given to an embodiment of the invention in which the ammonium nitrite that is formed in the NO elimination step is reacted with ammonia to form nitrogen in a thermal reduction step. Preferably, this thermal reduction step is connected to the (bottom) counterflow column.

Further preference is given to an embodiment of the invention in which ammonium sulphate is precipitated from the scrubbing solution with calcium oxide, with liberation of ammonia, and the ammonia liberated in this process is fed to the scrubbing solution used in the reduction step, the NO elimination step and/or the upstream scrubbing step. The gypsum arising as solid in the precipitation can be utilized commercially. The ammonia that is formed in this process, in contrast, can, depending on the plant or the process procedure, either be fed to a desulphurization process that is upstream of the denoxing (NO₂ reduction and NO elimination) and where it is used to generate the ammonium sulphite for the reduction step, or be introduced directly into a denoxing or NOₓ/SOₓ combination process.

The NO elimination step is preferably conducted at a temperature of 10 to 50° C. and a pressure of 10 to 40 bar, preferably at a pressure of 20-27 bar. The reduction step, according to a preferred embodiment, is conducted at a temperature of 50 to 95° C. and a pressure of 10 to 40 bar, preferably at a pressure of 20-27 bar. However, it can also be operated in the preferred temperature range of the NO elimination step (i.e., 10 to 50° C.).

According to a preferred embodiment, at least some of the carbon dioxide that is present in the exhaust gas stream is separated off by a membrane in a membrane separation step before the oxygen-containing gas stream is contacted with the scrubbing solution in a first reduction step. This embodiment particularly comes into consideration for sequestration methods in which the carbon dioxide is separated off by a membrane.

According to a preferred alternative method of this embodiment, the proximal SOₓ scrubbing step proceeds in a separate scrubber before a membrane separation step. Alternatively, SOₓ can also be separated off in a reactor together with the nitrogen oxides.

According to a further aspect of the invention, a plant for carrying out the method according to the invention is provided. Such a plant comprises a bottom gas-liquid counterflow column having a bottom gas feedline for introducing an exhaust gas stream, a bottom contact zone arranged downstream of the bottom gas feedline in the direction of the flow of the gas stream, a bottom scrubbing solution feedline for introducing a scrubbing solution containing ammonia and ammonium sulphite, a first gas outlet line arranged downstream of the bottom contact zone in the direction of the flow of the gas stream, and a bottom liquid outlet line, through which the scrubbing solution is removed from the bottom column. In addition, the plant also comprises a top gas-liquid counterflow column that is arranged downstream of the first gas outlet line from the bottom gas-liquid counterflow column in the direction of the flow of the gas stream. The gas-liquid counterflow column has a top scrubbing solution feedline for introducing a scrubbing solution containing ammonia, a top contact zone, a top liquid outlet line, and a top gas outlet line. The contact zones in each case are designed in such a manner that an exchange as intimate as possible takes place between the exhaust gas stream and the scrubbing solution.

The top gas-liquid counterflow column is arranged in a pressure vessel designed for operations at 10-50 bar overpressure, and the bottom liquid outlet line is connected to a device for thermal nitrite decomposition and/or a device for precipitating sulphate that is present in the liquid that is taken off.

Preferably, the bottom and top gas-liquid counterflow columns are arranged in the same pressure vessel, and therefore together form a nitrogen oxide scrubber.

Preferably, the top and bottom gas-liquid counterflow columns can be operated at different temperatures. This makes possible separate selection of the temperatures in order to favor the partial reactions proceeding in the respective columns.

This manner of plant operation makes possible the reaction of the NO₂ present in an unpurified exhaust gas stream with ammonium sulphite to form nitrogen and ammonium sulphate. The ammonium sulphite forms in this case either (a) by reaction of the sulphur dioxide present in the unpurified exhaust gas stream with the ammonia present in the scrubbing solution, or (b) is obtained, as described hereinafter, in a separate SOₓ scrubber (proximal column) situated upstream (proximal to the combustion boiler) of the denoxing.

According to an alternative preferred embodiment of this aspect of the invention, upstream of the denoxing, a proximal scrubbing step is provided for removing the SOₓ. In this case, the bottom scrubbing feedline is connected to a proximal counterflow column which has a proximal gas feedline for an exhaust gas stream, a proximal contact zone arranged downstream of the feedline in the direction of the gas stream, a proximal scrubbing solution feedline for introducing a scrubbing solution containing ammonia, and a proximal gas outlet line arranged downstream of the proximal contact zone in the direction of the gas stream. The contact zone is designed in such a manner that an exchange as intimate as possible takes place between exhaust gas stream and scrubbing solution. The proximal liquid outlet line assigned to this column is connected to the bottom scrubbing solution feedline of the bottom contact zone in such a manner that the ammonium sulphite-containing scrubbing water flowing out of the proximal column is passed to the bottom denoxing column. The gas flowing out of the proximal gas outlet line, in this embodiment, is passed to the bottom gas feedline of the bottom denoxing column.

According to a further preferred embodiment, the device for precipitating sulphate present in the liquid that is taken off is connected to the bottom scrubbing solution feedline in such a manner that the solution arising after precipitation of sulphate that is present can be fed to the bottom counterflow column of the denoxing. This plant type is preferred when no separate (proximal) desulphurization column is used.

According to an alternative preferred embodiment, the device for precipitating sulphate that is present in the liquid that is taken off is connected to the proximal scrubbing solution feedline in such a manner that the solution arising after the precipitation of sulphate that is present can be fed to the proximal counterflow column.

Incorporating the ammonium sulphite solution for reducing the NO₂ in the pressurized NOₓ scrubbing exploits existing synergies. At the same time, it assists the NOₓ scrubbing to achieve high nitrite selectivities, since the formation of nitrate from NO₂ is suppressed.

Nitrites are thermally unstable and can be converted to nitrogen at high temperatures. The ammonium sulphite solution supports the nitrite selectivity in the NOₓ scrubbing. Without ammonium sulphite, high nitrite selectivities are achieved only with low NO₂ contents, based on the total content of NOₓ in the gas. This is only possible at relatively low pressures (7-15 bar). This has a low NO conversion rate as a consequence and causes higher dimensions with respect to the plant components used as scrubbers. For higher NOₓ conversion rates for a small construction method, the incorporation of the NOₓ scrubbing at relatively high pressure is more expedient, but, owing to the high NO₂ contents at relatively high pressures, nitrate selectivity is lost and regeneration of the scrubbing medium is possible only with limitations. By using the ammonium sulphite solution, the NOₓ scrubbing can also be operated in a nitrite-selective manner at relatively high pressure ranges, since the NO₂ is already reduced to N₂ by the sulphite solution and cannot be converted to nitrate.

The reduction of the scrubbing medium of a nitrite-selective scrubber consumes ammonia. One mole of ammonia is required per mole of nitrite. Since ammonium sulphite is oxidized to ammonium sulphate and NO₂ is reduced in the course of this to nitrogen, for this part of the NOₓ, no ammonia is required, either for absorption or for reduction of the nitrites resulting from the NO₂ absorption. The use of an ammonium sulphite solution therefore decreases the ammonia consumption of the NOₓ scrubber.

The reduction of ammonium nitrite proceeds more effectively with increasing ammonia contents and decreasing pH. In the reduction of ammonium nitrite, ammonia is consumed and therefore the decomposition rate falls with decreasing ammonium nitrite concentration. This leads to the fact that a certain ammonium nitrite residue always remains in solution. Owing to the additional ammonium loading from the desulphurization, markedly higher amounts of ammonia are available and the decomposition reaction proceeds markedly faster and additionally achieves a lower nitrite level.

The reduction of NO₂ by ammonium sulphite requires an excess of SOₓ over NOₓ. In flue gases of power stations this is the case. However, owing to the high oxygen proportion, ammonium sulphite is further oxidized relatively rapidly to sulphate, and so a reduction of NO₂ is possible only with limitations. An embodiment of the invention is particularly suitable for use in oxyfuel power plants in which an upstream (proximal) desulphurization column is connected upstream of the return of the combustion gases (“recycle”) to the boiler. In the untreated exhaust gases there occurs the highest SO₂ loading with process-specific low oxygen contents. Therefore, an SOₓ scrubber is the most rational, in order to prevent acid gases from passing back into the boiler and concentrating in the recycle.

NOₓ, in contrast, does not concentrate in oxyfuel plants, despite recycle, and so in oxyfuel processes the ratio of the sulphur loading to the nitrogen loading is considerably higher in comparison with conventional coal power stations. This circumstance and the low oxygen contents in the flue gas favor a process for utilizing ammonium nitrite solutions for NOₓ reduction to nitrogen. Alternatively, the present invention also comes into consideration for purification of CO₂ from conventional power plants (e.g. coal-based power plants), in which the CO₂ is obtained by membrane separation in flue gases. Owing to the separation properties of such membranes, which do not have 100% selectivity, corresponding impurities and oxygen also pass into the CO₂ product. For further use, these impurities must be removed in order to achieve product specifications and avoid corrosion problems.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1A: shows plant schematics of a conventional pollutant removal from flue gases, e.g. in oxyfuel plants;

FIG. 1B: shows a hypothetical implementation of the Walter process in such a plant;

FIG. 1C: an embodiment of the plant according to the invention and of the process according to the invention;

FIG. 2: shows the nitrogen oxide scrubber as a part of a preferred embodiment of the plant according to the invention;

FIG. 3: shows a preferred embodiment of the plant according to the invention having a separate desulphurization column;

FIG. 4: shows a further preferred embodiment of the plant according to the invention with integrated denoxing and desulphurization column; and

FIG. 5: shows the plant schematic of the integration into a membrane process.

### EXAMPLES

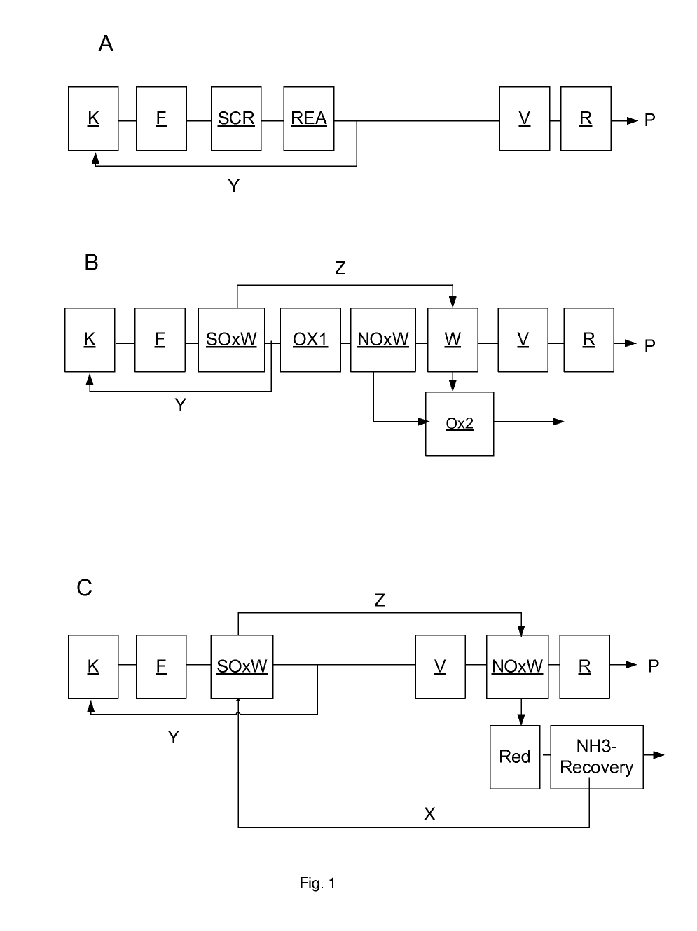

If a conventional elimination of pollutants from flue gases were to be installed, e.g. in oxyfuel plants, the circuit shown in FIG. 1A would be generated. In this case flue gas from a combustion boiler K is first dedusted by a filter unit F. In a subsequent selective catalytic reduction unit SCR, the nitrogen oxides are reduced and then the flue gas is desulphurized in a desulphurization unit REA. The resultant purified gas then passes through a compressor V and a CO₂ separator R. Some of the purified exhaust gases are recylced back to the combustion boiler K via recycle line Y. CO₂ product is removed from the CO₂ separator R.

FIG. 1B shows pollutant elimination from flue gases using an integrated wet-chemical Walter method. The flue gas of a boiler K is first dedusted by a filter unit F. Then, in a scrubber unit SOxW, sulphur oxides are separated off ammoniacally and then the nitrogen oxides are oxidized by ozone in an oxidation unit OX1. Then, ammoniacal scrubbing of the nitrogen oxides proceeds in a scrubber unit NOxW. Remaining ozone and NO₂ is removed in the unit W. Purified gas is then compressed in the unit V and freed from CO₂ in the CO₂ separator R. Nitrites and sulphite from the units NOxW and W are oxidized to nitrate and sulphate in an oxidation unit OX2. These can be further processed to fertilizers. Some of the purified exhaust gases are recylced back to the boiler via the recycle line Y. Z represents scrubbing water containing ammonium sulphite.

The plant according to the invention passes through at least one step of pollutant elimination at high pressure and utilizes, in addition, the ammonium sulphite loading for increasing nitrite selectivity and NO₂ reduction. The displacement to the pressure part, e.g., of sequestration plants, does not mean an increased expenditure in this case, since the pressure is also generated for the sequestration or the transport.

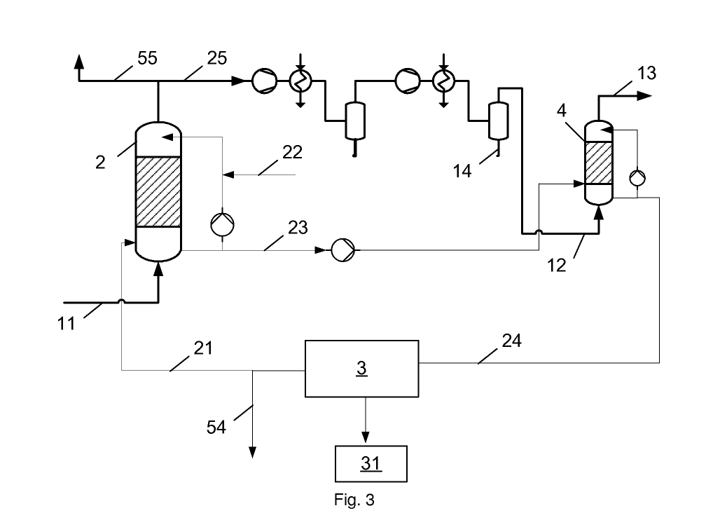

In FIG. 1C, the elimination of pollutants of flue gases according to a preferred embodiment of the invention is shown. Flue gas of a boiler K is first dedusted in a filter unit F and purified from SOx in a scrubber unit SOxW. In this process ammonium sulphite and ammonium sulphate are formed. After compression of the gas in V, the automatic oxidation of NO to NO₂ proceeds. NO₂ is reduced to N₂ in a unit NOxW by ammonium sulphite (Z) formed in the SOxW plant, wherein the ammonium sulphite is oxidized to ammonium sulphate. Excess NO₂, together with the NO present, forms nitrites, which are reduced thermally to elemental nitrogen in a unit Red. In the NH₃ Recovery unit, ammonia is regenerated by conversion of ammonium sulphate to gypsum via precipitation of the sulphates and fed back (X) to the process. After the gas is discharge from the NOxW unit, CO₂ is separated off from the purified gas in unit R. Some of the gas purified from sulphur oxides is recirculated via the line Y to the boiler (see line 55 in FIG. 3).

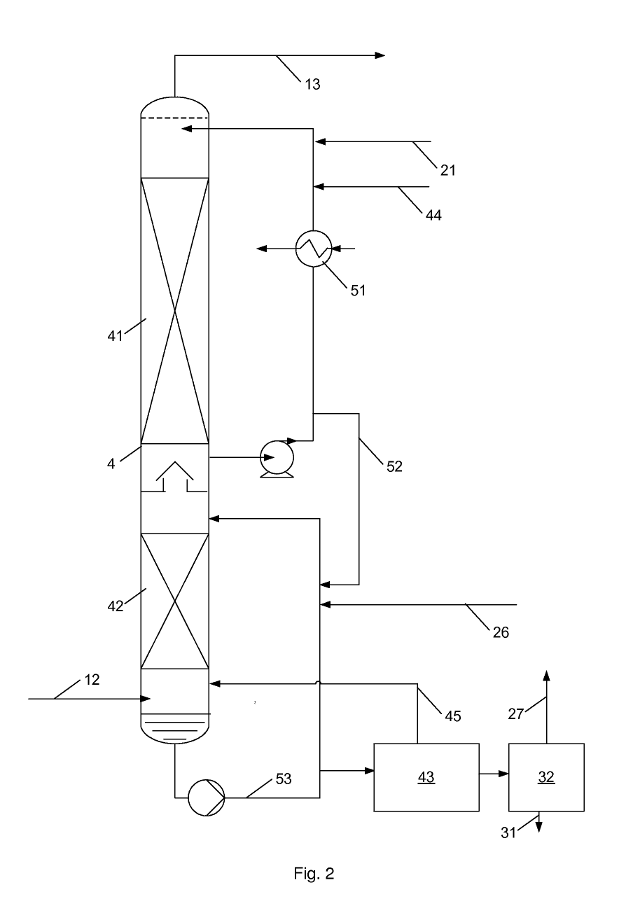

The plants shown in FIGS. 2 and 3 show preferred plant and process types. As shown in FIG. 3, the flue gas 11 is purified from SOₓ and forms ammonium sulphite and ammonium sulphate in the first scrubber (SOxW) 2. After compression of the gas to give compressed flue gas 12, the automatic oxidation of NO to NO₂ proceeds in the nitrogen oxide scrubber 4. The NO₂ is reduced to N₂ via the ammonium sulphite solution 26, 23 (FIGS. 2 and 3, respectively) and the ammonium sulphite is oxidized to ammonium sulphate. Excess NO₂, together with NO present, forms nitrites, which are converted to nitrogen in the thermal reduction step 43. The gases 45 formed in this process are returned to the bottom column 42. As in the double-alkali method, the ammonia is recovered in the regeneration unit 32 by precipitation of the sulphates to form gypsum 31 and recirculated to the process (X).

The recovered ammonia serves as scrubbing medium. Ammonia losses can be compensated for by feeding ammonia fed externally (“makeup”) to the process.

The NOₓ scrubber 4 consists of two parts, top scrubber part 41 and bottom scrubber part 42. The bottom part 42 is fed with the ammonium sulphite solution obtained in order to reduce NO₂ present to N₂ and to oxidize the sulphite solution by O₂ to form ammonium sulphate. Bottom scrubber part 42 can be operated either cold (e.g. 20-50° C.) or warm (50-90° C.).

The top scrubber part 41 serves for eliminating residual NO to form nitrites. This reaction is preferably operated at relatively low temperatures and high pressures (20-50° C.). The pH and the temperature of the top scrubber circuit is kept constant (pH 5.5-7, preferably pH 6-6.5, at 20-50° C.) by the ammonia metering. Excess scrubber water 52 from the top scrubber part 41 is introduced into the bottom part of the scrubber 42. In order to achieve high conversion rates of NOₓ, operation of the scrubber at pressures within the range of 10 to 27 bar and at oxygen contents >3% by volume is preferred.

The fraction 52 taken off (“purge”) from the scrubbing liquid circuit in the top scrubbing part 41 is passed into the bottom scrubbing circuit 42. There, (if operated warm) the ammonium nitrites are decomposed to nitrogen. In the case of insufficient reaction (e.g. owing to cold operation of the bottom column 42), the combined scrubbing solutions can be subjected to a thermal reduction. In this process the ammonia present in excess reduces the nitrites to N₂ and the CO₂ is liberated from the scrubbing medium and returned back to the scrubber. In order to achieve low nitrite values, the solution can be additionally warmed by supplying heat.

In the subsequent precipitation of gypsum by the double-alkali method 32, 3 (FIGS. 2 and 3, respectively), the ammonia is recovered and recirculated 27, 21 (FIGS. 2 and 3, respectively) to the SOₓ scrubber.

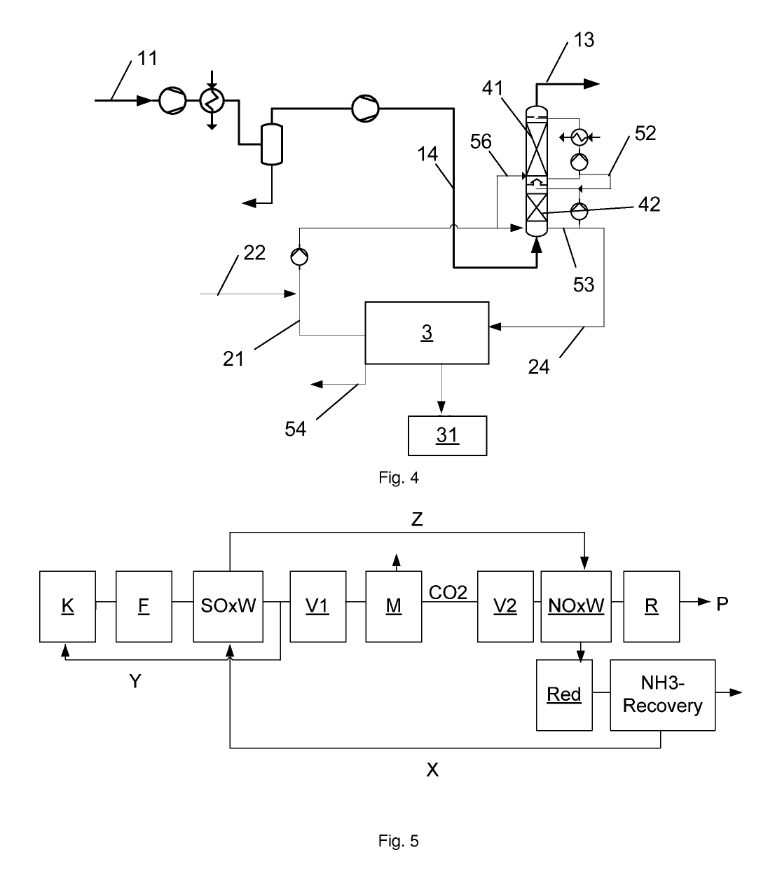

According to a further embodiment, the method can also provide for sulphur removal and nitrogen removal in one scrubber having two circuits or parts, as shown in FIG. 4.

The warm flue gas 11 is freed from SO₂ and SO₃ in countercurrent by way of an ammonia solution. At a sufficiently high ammonium sulphite content, the NO₂ is reduced to nitrogen. The top scrubber part 41 serves for ammonium nitrite production and is pH- and temperature-controlled. The ammonium nitrite solution passes via a purge 52 to the bottom scrubber part 42 and is there thermally reduced to nitrogen.

From a purge 53 removed from the bottom scrubber part 42, gypsum 31 is separated off from the ammonium-sulphate-rich solution in unit 3, and the scrubbing medium 21 is recirculated to both the top (line 56) and bottom scrubbing parts as required. Unit 3 is provided with a liquid purge line 54. Ammonia losses are replaced by make-up 22. Enrichments of acid gas components or dilution by water of condensation is avoided by the purge and the ammonia metering.

A further embodiment relates to application of the concept to the CO₂-Membrane-Based Post Combustion Capture application (FIG. 5).

In the first scrubber (SOxW), the flue gas is purified from SOₓ using an ammonia-alkaline scrubbing liquid to form ammonium sulphite and ammonium sulphate. After the first compression of the gas (V1), the CO₂ is separated off by a membrane (M). Nitrogen oxides that are still present in the CO₂ product are oxidized from NO to NO₂ by the residual oxygen. After the second compressor stage (V2), this oxidation proceeds more rapidly. In the NOxW scrubber, the NO₂ is reduced to N₂ by the ammonium sulphite solution (Z), obtained from the first scrubber (SOxW), and the ammonium sulphite is oxidized to ammonium sulphate. Excess NO₂ forms nitrites with NO that is present, and these nitrites are reacted to form nitrogen in the thermal reduction stage (Red). As in the double-alkali method, the ammonia is regenerated, recovered and recirculated to the process (X) by precipitation of the ammonium sulphates to form gypsum.

The following reactions give an overview of the chemical processes in the system:

SOₓ scrubber:

SO₂+2NH₃+H₂O→(NH₄)₂SO₃

NOₓ scrubber bottom part:

2NO₂+4(NH₄)₂SO₃→N₂+4(NH₄)₂SO₄

HNO₂+NH₃→N₂+2H₂O

NO scrubber top circuit or part:

2NO+0.5O₂+2NH₃+H₂O→2NH₄NO₂

Thermal decomposition of nitrite:

HNO₂+NH₃→N₂+2H₂O

Gypsum precipitation:

(NH₄)₂SO₄+CaO→2NH₃ (gas)+CaSO₄+H₂O (solid)

A simplified process is the circuit shown in FIG. 3. In this case, the ammonium sulphite is produced at atmospheric pressure in SOₓ scrubber 2. This ammonium sulphite solution 23 is used over the complete scrubber in the NOₓ scrubber as reducing agent for NO₂. The resultant ammonium sulphate is precipitated as gypsum 31 in ammonia regeneration unit 3, and the remaining ammonium solution 21 is recirculated to the low-pressure SOₓ scrubber 2. The ammonium makeup 22 serves for compensating for ammonia losses. The purge 54 prevents enrichment of salts such as ammonium chloride, ammonium nitrite and ammonium nitrate, and also other acid-gas components.

Therefore, for the entire reaction course, the following applies:

4SO₂+8NH₃+4H₂O+2NO₂4CaO→4CaSO₄+8NH₃+4H₂O+N₂

4SO₂+2NO₂+4CaO→4CaSO₄+N₂

Therefore, with respect to the removal of nitrogen dioxide, ammonia consumption cannot be indicated formally; an important difference from other denoxing methods which have N₂ as end product.

The method embodiments and plants described have all of the advantages that, in contrast to conventional denoxing, no catalyst is necessary for NOₓ elimination. By recirculating ammonia from the gypsum precipitation, the ammonia consumption for the NOₓ removal and nitrite reduction is restricted to the consumption for elimination of non-oxidized NO.

Compared with the Walter method, no oxidizing agent is required, and the scrubber for ozone elimination is dispensed with. Furthermore, the nitrogen oxide scrubber can also be operated in a nitrite-selective manner at relatively high pressures. The end product produced is gypsum or—if the ammonia recycling is dispensed with—ammonium sulphate.

Last but not least, a less complex structure is made possible owing to the compressed gas stream.

The entire disclosure[s] of all applications, patents and publications, cited herein and of corresponding German Application No. 10 2011 014 007.7, filed Mar. 15, 2011, are incorporated by reference herein.

The preceding examples can be repeated with similar success by substituting the generically or specifically described reactants and/or operating conditions of this invention for those used in the preceding examples.

### LIST OF REFERENCE SIGNS

11 Gas feedline
12 Gas feedline for compressed flue gas
13 Gas outlet line for purified flue gas to CO₂ purification
14 Compressed flue gas
2 Counterflow column for SOₓ scrubber
21 Ammonia-containing solution
22 Ammonia makeup feedline
23 Ammonium sulphite solution
24 Ammonium sulphate solution
25 Low-pressure SOₓ
26 Ammonium sulphite from SOₓ scrubber
27 Ammonia Reflux to SOₓ scrubber
31 Gypsum
32 Ammonia regeneration
4 Nitrogen oxide scrubber
41 Top gas-liquid counterflow column
42 Bottom gas-liquid counterflow column
43 Thermal nitrite decomposition
44 H₂O
45 Gas products
51 Cooling device
52 Top liquid outlet line
53 Bottom liquid outlet line
54 Liquid purge line
55 Recycle line to the boiler
56 Ammonia Feedline
F Filter
K Boiler
R Purification of CO₂
REA Flue gas desulphurization
Red Reduction stage to nitrogen
OX1 NOₓ oxidation by ozone
OX2 Oxidation of nitrites and sulphites to nitrate and sulphate
V Compressor
V1 Compressor 1
V2 Compressor 2
W Scrubber for ozone and NO₂ purification
Y Return line to the boiler
Z Ammonium sulphite solution

1. A method for depleting nitrogen oxides from an oxygen-containing gas stream, said method comprising:
bringing the gas stream is into contact with a scrubbing solution containing ammonia and ammonium sulphite in a NO₂ reduction, wherein NO₂ present in the gas stream is reduced to N₂, and
reacting nitrogen monoxide present in the gas stream with ammonia and oxygen to form ammonium nitrite in an NO elimination,
wherein the reaction of the nitrogen monoxide in the NO elimination proceeds at a pressure of at least 2 bar.

2. The method according to claim 1, wherein the reaction of the nitrogen monoxide in the NO elimination step proceeds at a pressure of 10 to 40 bar.

3. The method according to claim 1, wherein the reaction of the nitrogen monoxide in the NO elimination step proceeds at a pressure of 20-27 bar.

4. The method according to claim 1, wherein the scrubbing solution containing ammonium sulphite is obtained from a proximal scrubbing which is upstream of the NO₂ reduction and in which the gas stream is contacted with an ammonia-containing scrubbing solution.

5. The method according to claim 1, further comprising reacting nitrite, formed during the NO elimination, with ammonia by thermal reduction to form nitrogen.

6. The method according to claim 1, further comprising precipitating ammonium sulphate from the scrubbing solution using calcium oxide, with liberation of ammonia, and recycling liberated ammonia to the NO₂ reduction and/or the NO elimination.

7. The method according to claim 4, further comprising precipitating ammonium sulphate from the scrubbing solution using calcium oxide, with liberation of ammonia, and recycling liberated ammonia to the upstream scrubbing step.

8. The method according to claim 1, wherein the NO elimination is conducted at a temperature of 10 to 50° C. and a pressure of 10 to 40 bar.

9. The method according to claim 1, wherein the NO elimination is conducted at a temperature of 10 to 50° C. and a pressure of 20-27 bar.

10. The method according to claim 1, wherein the NO₂ reduction step proceeds at a temperature of 50 to 95° C. and a pressure of 10 to 40 bar.

11. The method according claim 1, wherein the NO₂ reduction proceeds at a temperature of 50 to 95° C. and a pressure of 20-27 bar.

12. The method according claim 1, wherein the oxygen-containing gas stream is the exhaust gas stream of an oxyfuel process.

13. The method according to claim 12, wherein at least some of the carbon dioxide that is present in the exhaust gas stream is separated off by a membrane in a membrane separation step before the oxygen-containing gas stream is contacted with the scrubbing solution in the NO₂ reduction.

14. The method according to claim 13, wherein the proximal scrubbing step proceeds before the membrane separation step.

15. A plant for carrying out a method according to claim 1, said plant comprising:
a bottom gas-liquid counter-flow column having a bottom gas feedline for introducing an exhaust gas stream, a bottom contact zone arranged downstream of the feedline in the direction of the flow of the gas stream, a bottom scrubbing solution feedline for introducing a scrubbing solution containing ammonia and ammonium sulphite, a first gas outlet line arranged downstream of the contact zone in the direction of the gas stream, and also a bottom liquid outlet line,
a top gas-liquid counterflow column that is arranged downstream of the first gas outlet line in the direction of the flow of the gas stream and having a top scrubbing solution feedline for introducing a scrubbing solution containing ammonia, a top contact zone and a top liquid outlet line,
wherein the top gas-liquid counterflow column is arranged in a pressure vessel designed for operations at 10-50 overpressure, and
wherein the bottom liquid outlet line is connected to a device for thermal nitrite decomposition and/or a device for precipitating sulphate that is present in the liquid that is taken off.

16. The plant according to claim 15, wherein the bottom and top gas-liquid counterflow columns are arranged in the same pressure vessel.

17. The plant according to claim 15, wherein the top and bottom gas-liquid counterflow columns can be operated at different temperatures.

18. The plant according to claim 16, wherein the top and bottom gas-liquid counterflow columns can be operated at different temperatures.

19. The plant according to claim 15, wherein the bottom scrubbing feedline is connected to a proximal counterflow column which has a proximal gas feedline for an exhaust gas stream, a proximal contact zone arranged downstream of the feedline in the direction of the gas stream, a proximal scrubbing solution feedline for a scrubbing solution containing ammonia and a proximal gas outlet line arranged downstream of the proximal contact zone in the direction of the gas stream, and also a proximal liquid outlet line which is connected to the bottom scrubbing solution feedline of the bottom contact zone, wherein the is fed to the proximal gas outlet line of the bottom gas feedline.

20. The plant according to claim 15, further comprising a device, for precipitating sulphate present in the liquid that is taken off, is connected to the bottom scrubbing solution feedline in such a manner that the solution arising after precipitation of sulphate that is present can be fed to the bottom counterflow column.

21. The plant according to claim 19, further comprising a device, for precipitating sulphate that is present in liquid that is taken off, is connected to the proximal scrubbing solution feedline in such a manner that the solution arising after the precipitation of sulphate that is present can be fed to the proximal counterflow column.
